(19) United States
(12) Patent Application Publication
(10) Pub. No.: US 2017/0259372 A1
(43) Pub. Date: Sep. 14, 2017

(54) LASER WELDING APPARATUS CAPABLE OF PERFORMING BELLOWS WELDING

(71) Applicant: EO TECHNICS CO., LTD., Anyang-si (KR)

(72) Inventors: Su Hyun KIM, Seoul (KR); Ko Dong PARK, Uiwang-si (KR); Seong Wook RYU, Suwon-si (KR); Ki Young UM, Incheon (KR)

(73) Assignee: EO TECHNICS CO., LTD., Anyang-si (KR)

(21) Appl. No.: 15/357,284

(22) Filed: Nov. 21, 2016

(30) Foreign Application Priority Data
Mar. 8, 2016 (KR) 10-2016-0027703

(51) Int. Cl. B23K 26/00; G02B 6/32; B23K 26/70; G02B 6/36

(52) U.S. Cl. CPC B23K 26/0006; G02B 6/3624; G02B 6/3672; G02B 6/32; B23K 26/704

(57) ABSTRACT

A laser welding apparatus includes a laser head for irradiating laser beams transferred through a plurality of transferring optical fibers to a processing target connected thereto via a connector, wherein the laser head includes an optical fiber block having an accommodating space for accommodating the plurality of transferring optical fibers to be arranged along a first direction, and an optical system disposed in front of the optical fiber block and irradiating the laser beams transferred through the plurality of transferring optical fibers to the processing target.

### CROSS-REFERENCE TO RELATED APPLICATION

This application claims the benefit of Korean Patent Application No. 10-2016-0027703, filed on Mar. 8, 2016, in the Korean Intellectual Property Office, the disclosure of which is incorporated herein in its entirety by reference.

### BACKGROUND

1. Field

One or more embodiments relate to a laser welding apparatus capable of performing bellows welding.

2. Description of the Related Art

A bellows is a component having a flexible tube shape allowing it to be contracted or expanded due to an external force. Such a bellows may be classified as a molding bellows or a welding bellows, according to a manufacturing method thereof.

The molding bellows is formed by a molding method, and thus, is relatively cheap, but has limitations in shape thereof and decreased hermeticity. On the other hand, the welding bellows is formed by connecting a plurality of diaphragms through a welding process, and thus, is relatively expensive, but has no limitation in shape thereof and has excellent hermeticity.

As an example of a method of welding the welding bellows, a method using a tungsten inert gas, a method using plasma, and a method using an electron beam may be used. However, the above welding methods have degraded energy integrity, and thus, it is difficult to perform precise processing, there may be thermal damage on a processed portion, and processing speed may degrade.

As attempts to address the problems of the above welding methods, a laser welding method may be used to weld the welding bellows. For example, the laser welding may be performed by using an optical fiber laser.

However, in a case of laser welding using an optical fiber laser, a laser beam irradiated to a processing target produces a circle having a diameter of 0.1 mm to 0.2 mm, and an energy concentration per unit area of the laser beam at an output of 500 W may be about 4 MW/cm². During a process of irradiation such as with the laser beam onto a thin external edge or an internal edge of the bellows, a temperature of a processed portion (or a welded portion) may increase significantly. Accordingly, the processed portion may be damaged during the welding process, and uniform processing quality may not be obtained. In addition, during the welding process, the processed portion may be blackened, and noxious gas or flying material including metal may be generated. Moreover, an operating environment may become contaminated and the quality of a final product may be degraded.

In addition, since the laser beam is reflected or dispersed by the processed portion of the processing target, the laser beam may be incident again into a laser head. When the laser beam is re-incident, the optical fibers in the laser head may become broken.

### SUMMARY

One or more embodiments include a laser welding apparatus capable of expanding an irradiation range of a laser beam in a horizontal direction and dispersing an energy density per unit area, in order to improve processability and productivity even if a processing target has a very thin welding portion such as a bellows.

One or more embodiments include a laser welding apparatus capable of preventing transferring optical fibers disposed in a laser head from becoming damaged, even when a laser beam is reflected or dispersed by a processing target and incident into the laser head.

Additional aspects will be set forth in part in the description which follows and, in part, will be apparent from the description, or may be learned by practice of the presented embodiments.

According to one or more embodiments, a laser welding apparatus including: a plurality of laser diodes; a plurality of transferring optical fibers connected to the plurality of laser diodes for transferring laser beams generated by the plurality of laser diodes; a laser head irradiating the laser beams to a processing target; and an optical connector for connecting the plurality of transferring optical fibers to the laser head, and for transferring the laser beams transferred through the plurality of transferring optical fibers to the laser head, wherein the optical connector include an optical fiber block having an accommodation space for accommodating the plurality of transferring optical fibers so that an end portion of each of the plurality of transferring optical fibers is arranged in a first direction, and the laser head includes an optical system for irradiating the laser beams emitted from the optical connector to the processing target.

The laser beams irradiated to the processing target may be focused at a focal distance of a focusing lens by adjusting a distance between the laser head and the processing target, or the laser beams irradiated to the processing target may form a line beam shape at a point out of a focal distance of a focusing lens.

The plurality of transferring optical fibers accommodated in the accommodation space may be arranged in at least one row and a plurality of columns.

The optical fiber block may have a surface facing the laser head, the surface having a material having reflectivity of 80% or greater against the laser beam.

The optical fiber block may have thermal conductivity of 200 W/mK to 430 W/mK.

The optical fiber block may include at least one of aluminum (Al), copper (Cu), silver (Ag), and gold (Au).

The optical connector may further include a quartz block fused to bond to each of the end portions of the plurality of transferring optical fibers.

The laser diode may have an output power of 1 W to 10 kW.

### BRIEF DESCRIPTION OF THE DRAWINGS

These and/or other aspects will become apparent and more readily appreciated from the following description of the embodiments, taken in conjunction with the accompanying drawings in which:

FIGS. 1A and 1B are respectively a perspective view and a cross-sectional view of a processing target that is welded by a laser welding apparatus according to an embodiment;

FIG. 2 is a diagram showing an example of a diaphragm of FIG. 1A;

FIG. 3 is a diagram of a laser welding apparatus according to an embodiment;

FIGS. 4A and 4B are diagrams showing an example of an optical fiber block in an optical connector of FIG. 3;

FIG. 5 is a diagram showing an accommodation space according to an embodiment;

FIG. 6 is a conceptual diagram showing a state in which a laser beam is irradiated to a processing target;

FIGS. 7A and 7B are graphs showing beam profiles of a laser beam irradiated from the laser welding apparatus according to the embodiment, wherein FIG. 7A shows a beam profile of the laser beam at a focal distance of a focusing lens and FIG. 7B shows a beam profile of a laser beam at a point out of the focal distance of the focusing lens;

FIG. 8 is a conceptual diagram illustrating the laser beam that has been irradiated to a processing target from a laser head and is reflected to be incident to the laser head;

FIGS. 9A and 9B are graphs showing reflectivities of aluminum (Al), copper (Cu), silver (Ag), and gold (Au) according to a wavelength of a laser beam, wherein FIG. 9A shows reflectivities measured at room temperature (25° C.) and FIG. 9B shows reflectivities measured at a temperature of 100° C.; and

FIG. 10 is a perspective view of a laser head according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

While such terms as “first,” “second,” etc., may be used to describe various components, such components must not be limited to the above terms. The above terms are used only to distinguish one component from another. For example, a first component may be referred to as a second component, and similarly, a second component may be referred to as a first component.

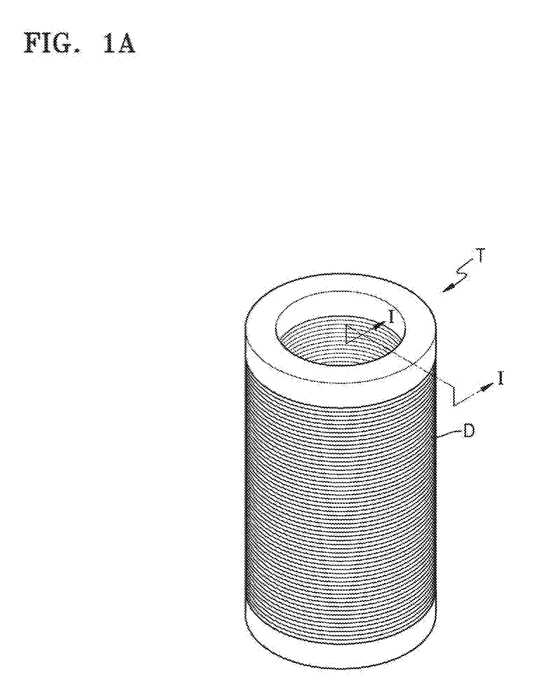

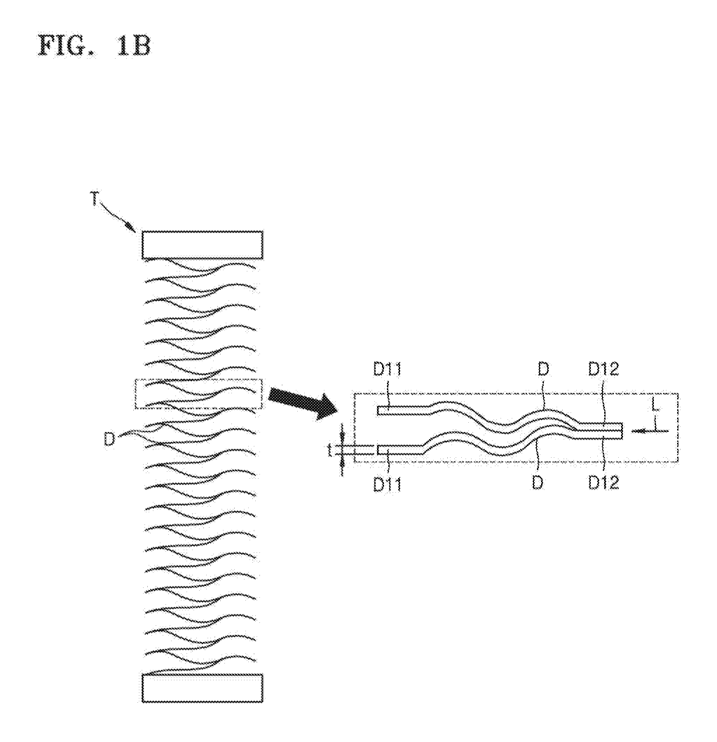

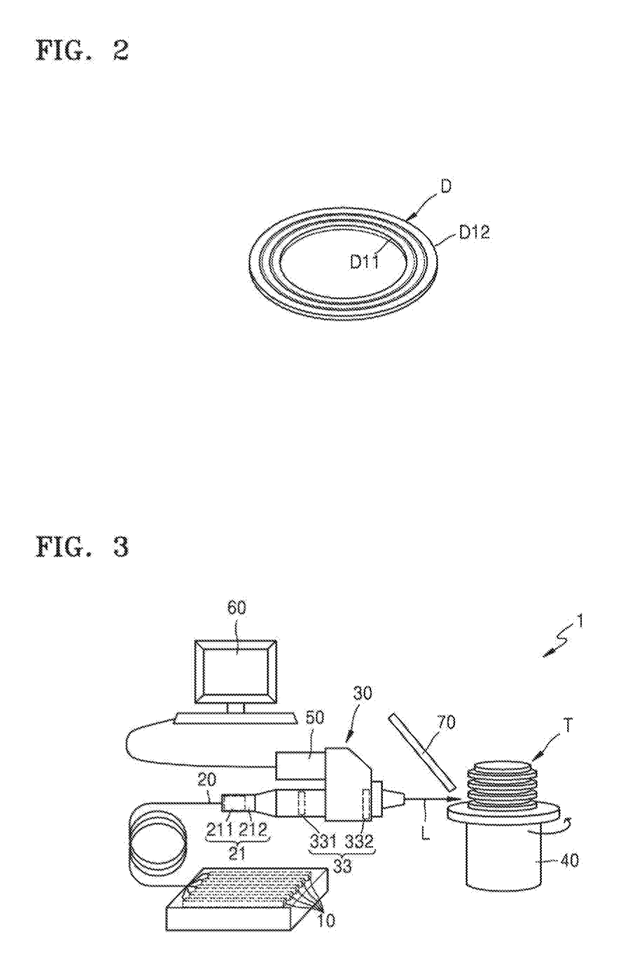

FIGS. 1A and 1B are respectively a perspective view and a cross-sectional view schematically showing a processing target T that is welded by a laser welding apparatus according to an embodiment. FIG. 2 is a diagram showing an example of a diaphragm D of FIG. 1A.

Referring to FIGS. 1A, 1B, and 2, the processing target T may be a metal bellows formed as a stretchable pipe. The metal bellows may be used as a component in various apparatuses or machines such as a valve, a vehicle component, and semiconductor vacuum equipment.

The processing target T may be formed by arranging a plurality of diaphragms D to overlap one another in a vertical direction, and by connecting the plurality of diaphragms D to one another in order to form a flexible shell structure having multiple convolutions. Each of the diaphragms D has a ring shape and includes a metal material, and has an internal boundary D11 corresponding to an inner diameter and an external boundary D12 corresponding to an outer diameter. A thickness t of the diaphragm D is equal to or less than 2 mm, for example, 0.1 mm or less.

In order to manufacture the processing target T, a laser beam L is irradiated to a connecting portion between adjacent diaphragms D to connect the adjacent diaphragms D to each other via laser welding. For example, the internal boundaries D11 of the adjacent diaphragms D are laser welded together to form a unit cell having a wave form, and unit cells obtained as above are stacked to overlap one another and the external boundaries D12 of the diaphragms D in the unit cells are welded together to manufacture the processing target T.

As described above, the welding of the processing target T is performed on the internal boundaries D11 or the external boundaries D12 of the plurality of diaphragms D, and thus, a welding portion that needs to be welded may be very thin. For example, a thickness of the welding portion may be equal to or less than 0.1 mm.

When the welding is performed by irradiating a general laser beam onto the welding portion that is very small in thickness, an energy density of the laser beam per unit area may be concentrated onto the welding portion, and accordingly, the processing target may become damaged, and thus, welding quality degrades and processability decreases. Moreover, it is necessary to carry out a process of cleaning smoke or soot that may be generated during welding, and accordingly, productivity may also degrade.

A laser welding apparatus 1 according to the embodiment provides a structure capable of dispersing energy density per unit area by expanding a welding portion, in order to improve processability and productivity even if the welding portion is very thin as described above.

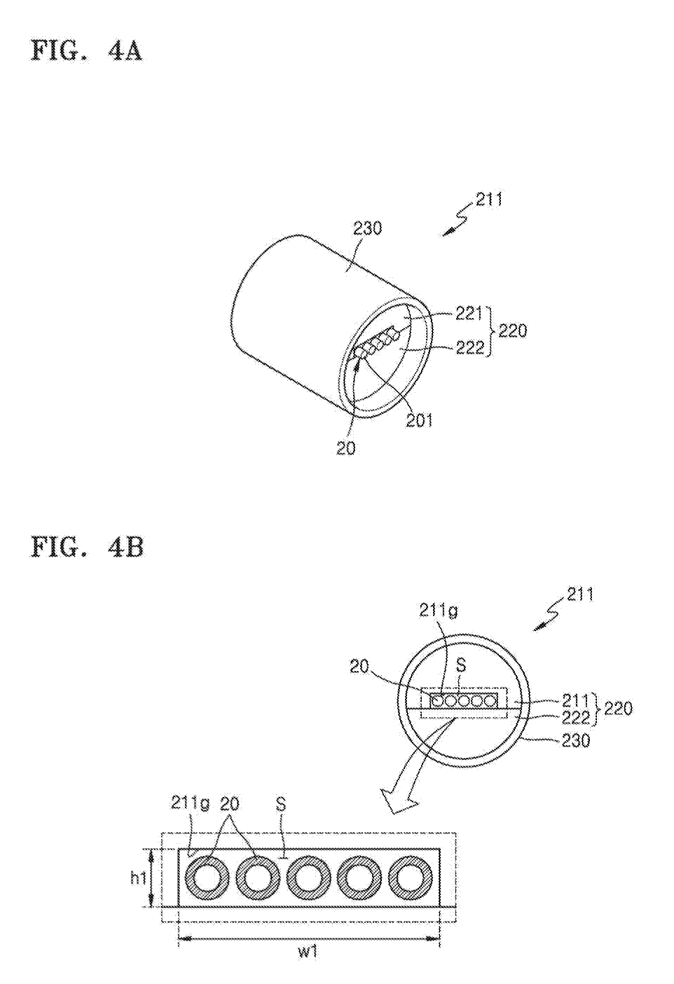

FIG. 3 is a diagram of the laser welding apparatus 1 according to the embodiment, and FIGS. 4A and 4B are diagrams showing examples of an optical fiber block 211 in an optical connector 21 of FIG. 3.

Referring to FIG. 3, the laser welding apparatus 1 according to the embodiment includes a plurality of laser diodes 10, a plurality of transferring optical fibers 20 for transferring laser beams emitted from the plurality of laser diodes 10, the optical connector 21 including the optical fiber block 211 that aligns end portions of the plurality of transferring optical fibers 20, and a laser head 30 that may irradiate the laser beam emitted through the optical connector 21 onto the processing target T.

Each of the plurality of laser diodes 10 may generate a laser beam of a predetermined wavelength. If necessary, the plurality of laser diodes 20 may generate laser beams having wavelengths that are similar to or different from one another. For example, the plurality of laser diodes 10 may generate laser beams having a wavelength of 800 nm to 1000 nm. Here, similar wavelengths may denote wavelengths that are equal to each other or have a difference of 10 nm or less, and different wavelengths may denote wavelengths having a difference greater than 10 nm.

Output powers from the plurality of laser diodes 10 may range from 1 W to 10 kW, and if necessary, the output powers of the laser diodes 10 may be similar to or different from one another. Here, the similar output powers may denote that the output powers may be equal to each other or a difference between the output powers may be equal to or less than 10 W. The different output powers may denote that a difference between the output powers may be greater than 10 W.

The plurality of transferring optical fibers 20 are connected to the plurality of laser diodes 10, and may transfer the laser beams emitted from the plurality of laser diodes 10 to the laser head 30 via the optical connector 21. The number of the transferring optical fibers 20 is equal to the number of the laser diodes 10.

Surfaces 201 on one of the end portions (hereinafter, referred to as cross-sections 201) of the plurality of transferring optical fibers 20 may be anti-reflection coated. Accordingly, the laser beams transferred through the plurality of transferring optical fibers 20 may be prevented from being reflected by the end portions of the transferring optical fibers 20 and returning to the laser diodes 10.

The laser head 30 is connected to the plurality of transferring optical fibers 20 via the optical connector 21, and irradiates the laser beams transferred by the plurality of transferring optical fibers 20 to the processing target T.

The optical connector 21 may include an optical fiber block 211 supporting the plurality of transferring optical fibers 20 to be arranged in a predetermined type, and a connector tool portion 212 that connects the optical fiber block 211 to the laser head 30. The laser head 30 includes an optical system 33 that condenses the laser beams transferred by the plurality of transferring optical fibers 20 and irradiates the laser beam to the processing target T.

Referring to FIGS. 4A and 4B, the optical fiber block 211 may have an accommodation space S for accommodating the plurality of transferring optical fibers 20. The optical fiber block 211 may include an internal block 220 forming the accommodation space S and an external block 230 surrounding the internal block 220. The internal block 220 may include an upper block 221 and a lower block 222.

An accommodation recess 221g for forming the accommodation space S may be formed in at least one of the upper block 221 and the lower block 222. For example, the accommodation recess 221g for forming the accommodation space S may be formed in the upper block 221.

The cross-section 201 of each transferring fiber 20 disposed in the accommodation space S may be disposed to protrude about 1 mm from the internal block 220. The cross-section 201 of each transferring optical fiber 20 may be spaced apart a similar distance from the internal block 220 to the other cross-sections 201 of the optical fibers 20. Here, the similar distances to one another may denote equal distances or distances with differences of 1% or less.

Arrangement of the plurality of transferring optical fibers 20 in the accommodation space S may vary depending on the shape of the accommodation space S. For example, the accommodation space S may have a width w1 in a horizontal direction (or first direction) and a height h1 in a vertical direction (or second direction), wherein the width w1 may be greater than the height h1. For example, the width w1 of the accommodation space S in the horizontal direction may be three times or more greater than the height h1 in the vertical direction, e.g., five times greater than the height h1.

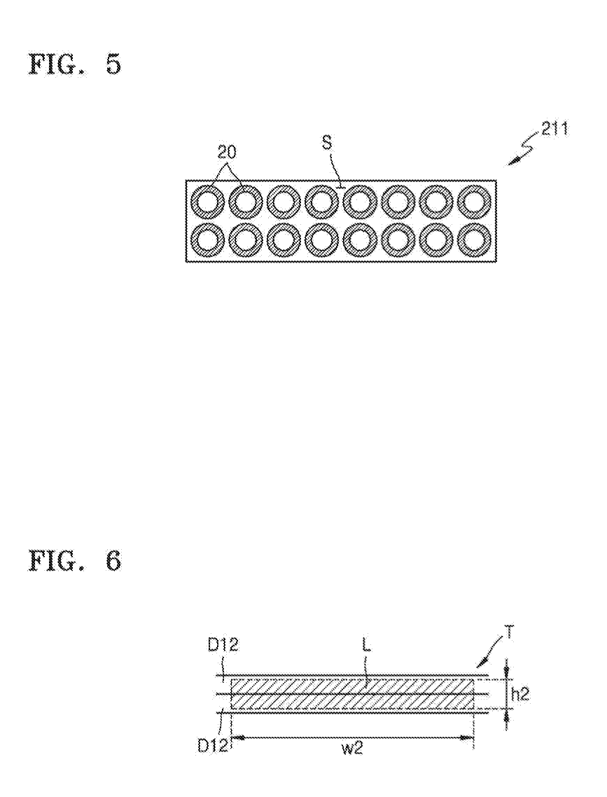

As described above, since the width w1 of the accommodation space S in the horizontal direction is greater than the height h1 in the vertical direction, the plurality of transferring optical fibers 20 in the accommodation space S may be arranged in the horizontal direction. The plurality of transferring optical fibers 20 may be arranged so as to have at least one row and a plurality of columns. For example, five transferring optical fibers 20 may be arranged in one row and five columns. However, the arrangement of the plurality of transferring optical fibers 20 is not limited thereto, that is, the arrangement may vary depending on diameters of the plurality of transferring optical fibers 20, the number of transferring optical fibers 20, and the shape of the accommodation space S. For example, the plurality of transferring optical fibers 20 may be arranged in two lines as shown in FIG. 5, or arranged in more than two lines.

The accommodation space S may have a height and a width respectively corresponding to sum of the heights and sum of the widths of the plurality of transferring optical fibers 20, so as to support the plurality of transferring optical fibers 20 inserted therein. For example, when five transferring optical fibers 20 are accommodated in the accommodation space S, the height h1 of the accommodation space S is similar to that of one transferring optical fiber 20, and the width w1 of the accommodation space S may be similar to sum of the widths of the five transferring optical fibers 20. Here, that the foregoing are similar may denote that they are equal to each other or that there is a difference between them of 10% or less. That is, the height h1 of the accommodation space S may be equal to or greater than an outer diameter of the transferring optical fiber 20, and even if the height h1 is greater than the outer diameter of the transferring optical fiber 20, the difference between the height h1 and the outer diameter may be 10% of the outer diameter of the transferring optical fiber 20 or less. In addition, the width w1 of the accommodation space S may be equal to or greater than sum of the outer diameters of the plurality of transferring optical fibers 20 that are arranged in the width direction, and even if the width w1 may be greater than the sum of the outer diameters, the difference between the width w1 and the sum of the outer diameters may be 10% of the outer diameter of the transferring optical fiber 20 or less.

Referring back to FIG. 3, the optical system 33 is disposed in front of the cross-sections 201 of the plurality of transferring optical fibers 20 accommodated in the accommodation space S. The optical system 33 may include a collimating lens 331 and a focusing lens 332.

The laser beam transferred through the plurality of transferring optical fibers 20 may pass through the collimating lens 331 and the focusing lens 332 to be irradiated to the processing target T. As described above, since the plurality of transferring optical fibers 20 are arranged in the horizontal direction in the accommodation space S of the optical fiber block 211, if a distance between the processing target T and the focusing lens 332 is equal to a focal distance of the focusing lens 332, the laser beams emitted respectively from the cross-sections 201 are condensed and irradiated, and if a distance between the processing target T and the focusing lens 332 exceeds the focal distance of the focusing lens 332, the laser beams will be out of focus and overlap each other and may form a line beam shape. For example, the laser beam L of the line beam shape irradiated to the processing target T has a height h2 of, for example, 0.5 mm or less, in the vertical direction, and a width w2 in the horizontal direction, wherein the width w2 in the horizontal direction may extend longer than the height h2 in the vertical direction.

The distance between the processing target T and the focusing lens 332 may be adjusted by moving at least one of the processing target T and the laser head 30. For example, the laser head 30 may be moved to adjust the distance between the processing target T and the focusing lens 332.

FIG. 6 is a conceptual diagram showing a state in which the laser beam L is irradiated to the processing target T. Referring to FIG. 6, the laser beam L irradiated to the processing target T has the width w2 that is greater than the height h2 in the vertical direction.

The laser beam L of the line beam shape may have an extended irradiation range in the horizontal direction as compared with a circular-type laser beam, and thus, a welding portion that is small in width may be welded quickly.

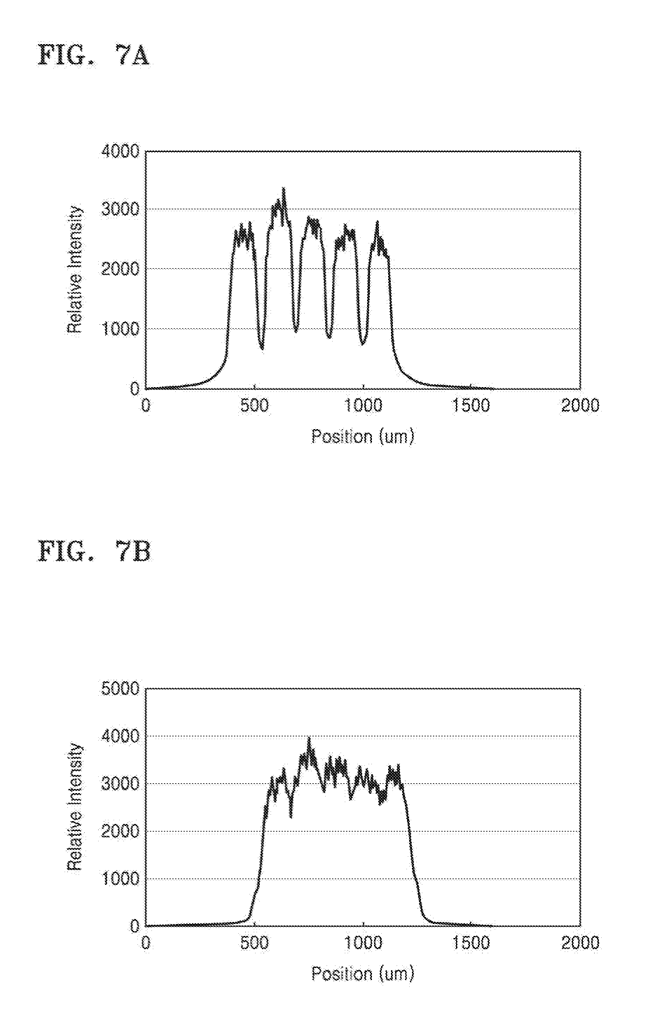

FIGS. 7A and 7B are graphs showing a beam profile of the laser beam L irradiated from the laser welding apparatus 1 according to the embodiment, wherein FIG. 7A shows a beam profile of the laser beam L at the focal distance of the focusing lens 332, and FIG. 7B shows a beam profile of the laser beam L out of the focal distance of the focusing lens 332.

Referring to FIG. 7A, when the distance between the processing target T and the focusing lens 332 is equal to the focal distance of the focusing lens 332, the laser beams L emitted from all the transferring optical fibers 20 are focused on the processing target T, and thus, the energy densities of the laser beams L irradiated to the processing target T may vary depending on the laser diodes 10. However, referring to FIG. 7B, when the distance between the processing target T and the focusing lens 332 is shorter or longer than the focal distance, the energy density of the laser beam L irradiated to the processing target T is uniform. The location of the processing target T is determined by a processing degree according to a material and a shape of the processing target T, for example, the location of the processing target T may be determined to be within a range of ±10% of the focal distance of the focusing lens 332.

In addition, referring back to FIG. 3, the laser welding apparatus 1 according to the embodiment has a structure in which the laser beam L irradiated to the processing target T is generated by transferring the laser beam emitted from the laser diode 10 via the transferring optical fibers 20. The laser welding apparatus 1 according to the embodiment does not include active optical fibers for additional light pumping like in a type of using optical fiber laser, and thus, a wavelength of the laser beam L irradiated to the processing target T is equal to a wavelength of the laser beam emitted from the laser diode 10. For example, when the wavelength of the laser beam emitted from the laser diode 10 ranges from 800 nm to 1000 nm, the laser beam L irradiated to the processing target T also has a wavelength ranging from 800 nm to 1000 nm.

Also, since the laser welding apparatus 1 according to the embodiment does not include the active optical fibers for additional light pumping like in the type of using optical fiber laser, the energy density of the laser beam irradiated to the processing target T may be relatively smaller than that of the laser beam irradiated to the processing target T in a case of using the optical fiber laser at the same output power.

As such, the energy density of the laser beam L irradiated to the processing target T per unit area is reduced, and thus, rapid rising of the temperature at the welding portion of the processing target T may be prevented, and accordingly, blackening of the welding portion may be prevented. Therefore, welding quality of the processing target T may be improved.

Wavelengths of the laser beams emitted from the laser diodes 10 may be equal to or different from each other, and then, the laser beams may be irradiated to the processing target T.

In addition, the laser welding apparatus 1 may further include a work table 40 on which the processing target T is mounted, a vision camera 50 for capturing images of the processing target T, and a display unit 60 for displaying the welding portion.

The work table 40 may be rotatable. Accordingly, the laser beam L irradiated by the laser head 30 may be continuously irradiated to the outer boundary D12 or the inner boundary D11 of the processing target T.

The vision camera 50 is disposed on the laser head 30, and the display unit 60 may be connected to the vision camera 50. Accordingly, an operator may monitor whether the welding on the welding portion of the processing target T is being appropriately performed, based on information displayed on the display unit 60.

The laser welding apparatus 1 may further include an anti-oxidation nozzle 70. The anti-oxidation nozzle 70 may spray inert gas to the welding portion. The inert gas may be nitrogen gas. Thus, oxidation of the welding portion may be prevented via the anti-oxidation nozzle 70.

During a process of irradiating the laser beam L to the processing target T such as a metal bellows having a thin welding portion, the laser beam L may be reflected or dispersed by the processing target T.

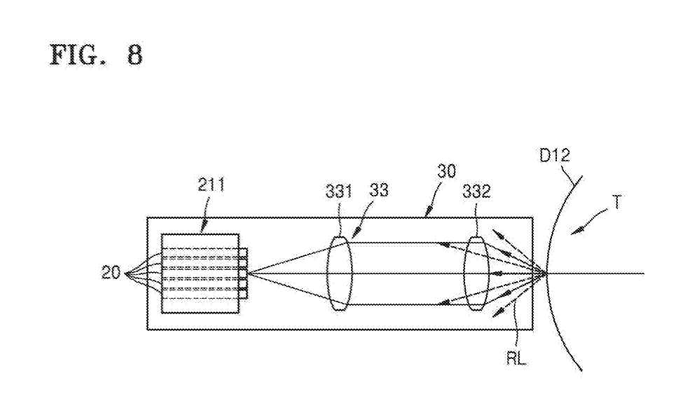

FIG. 8 is a conceptual diagram showing reflection of the laser beam irradiated from the laser head 30 to the processing target T so as to be re-incident into the laser head 30. Referring to FIG. 8, the laser beam transferred via the transferring optical fibers 20 is irradiated from the laser head 30 onto the processing target T via the collimating lens 331 and the focusing lens 332. Some of the irradiated laser beam L is absorbed by the processing target T and used in the welding process, but some other of the laser beam L may be reflected or dispersed by the processing target T. The laser beam RL reflected or dispersed by the processing target T may be incident into the laser head 30. The laser beam RL incident into the laser head 30 may be transferred to the optical fiber block 211 through the focusing lens 332 and the collimating lens 331.

When the laser beam RL incident into the laser head 30 is absorbed by the optical fiber block 211, the optical fiber block 211 may be heated. If the optical fiber block 211 is over-heated, the transferring optical fibers 20 accommodated in the accommodation space S may be damaged.

Therefore, the laser welding apparatus 1 according to the embodiment may provide a structure in which the transferring optical fibers 20 disposed in the laser head 30 may be prevented from being damaged even when the laser beam RL is incident into the laser head 30.

Referring back to FIG. 4A, when the optical fiber block 211 includes aluminium (Al), copper (Cu), silver (Ag), and gold (Au), reflectivity against the laser beam may be improved. The optical fiber block 211 having the above materials may have a reflectivity of 80% or greater with respect to the laser beam RL that is reflected by the processing target T to the optical fiber block 211 via the optical system 33 of the laser head 30. Accordingly, over-heating of the optical fiber block 211 due to the laser beam RL incident into the laser head 30 may be prevented.

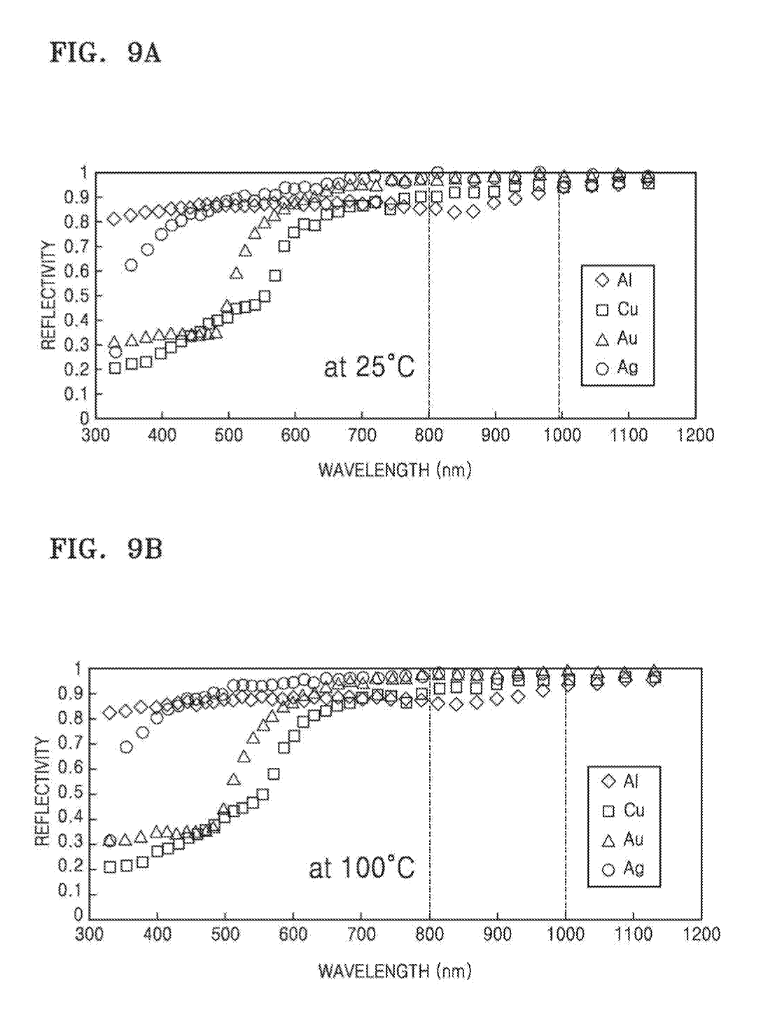

FIGS. 9A and 9B are graphs of reflectivities of Al, Cu, Ag, and Au according to a wavelength of the laser beam, wherein FIG. 9A shows the reflectivities measured at room temperature (25° C.), and FIG. 9B shows the reflectivities measured at a temperature of 100° C.

Referring to FIGS. 9A and 9B, Al, Cu, Ag, or Au may have reflectivity of 80% or greater with respect to a laser beam having a wavelength of 800 nm to 1000 nm within a predetermined temperature range, e.g., a range from 25° C. to 100° C.

Therefore, the optical fiber block 211 may include at least one of Al, Cu, Ag, and Au. Accordingly, when the laser beam RL incident into the laser head 30 has a wavelength of 800 nm to 1000 nm, 80% or greater of the laser beam RL incident into the optical fiber block 211 may be reflected. Thus, heating of the optical fiber block 211 due to the laser beam RL incident into the laser head 30 may be prevented.

In addition, the optical fiber block 211 may have thermal conductivity of 200 W/mK to 430 W/mK. For example, the optical fiber block 211 may include at least one of Al, Cu, Ag, and Au.

As described above, the optical fiber block 211 includes a material having excellent thermal conductivity and high reflectivity against the laser beam, and thus, the heat generated by the transferring optical fibers 20 may be easily discharged to the outside and heating of the optical fiber block 211 due to the laser beam RL incident to the laser head 30 may be prevented.

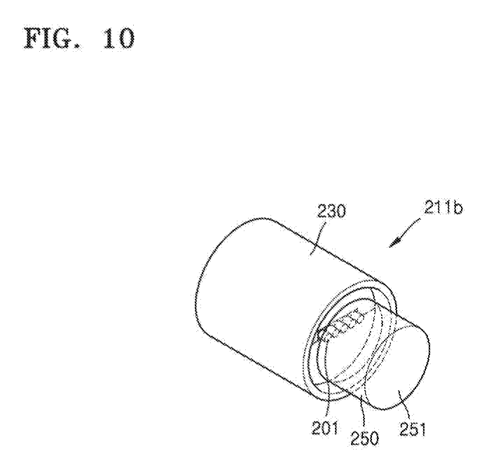

FIG. 10 is a perspective view of an optical fiber block 211b according to an embodiment. Referring to FIG. 10, the optical fiber block 211b may further include a structure obtained by bonding the cross-sections 201 of the transferring optical fibers 20 to a quartz block 250 through a fusing operation. A diameter of the quartz block 250 may be equal to or greater than the width w1 of the accommodation space S of the optical fibers, and a thickness of the quartz block 250 is determined so that the laser beam L may pass through a cross-section 251 of the quartz block 250 while taking into account a laser emission angle from the cross-section 201 of the transferring optical fiber 20 that is fused and bonded to the quartz block 250. In this case, the cross-section 201 of the optical fiber 20 is not non-reflective coated, and the cross-section 251 of the quartz block 250 is non-reflective coated. The laser beam transmitting through the cross-section 251 of the quartz block 250 is greater than the laser beam transmitting through the cross-section 201 of the transferring optical fiber 20, and thus, is less affected by dust and external shock. In addition, an energy density of the laser beam per unit area is reduced, and thus, damage on the coating due to the laser beam may be prevented. Further, since the end portion of a water-cooling structure (not shown) surrounding the transferring optical fiber 20 may be sealed by the quartz block 250, the heat generated by the laser beam RL incident into the laser head 30 may be cooled down by the water-cooling system and thus the transferring optical fiber 20 may not become damaged.

In the above embodiment, the horizontal direction and the vertical direction are based on the drawings, but the horizontal direction and the vertical direction may be exchanged according to arrangements of the laser welding apparatus 1 and the processing target T.

The laser welding apparatus according to the embodiment may improve processability and productivity by expanding the irradiation range of the laser beam irradiated to the processing target T and dispersing the energy density per unit area.

In addition, the laser welding apparatus may prevent the damage of the transferring optical fibers in the connector connected to the laser head even when the laser beam reflected by the processing target T is incident into the laser head, since the optical fiber block includes a material having excellent thermal conductivity and reflectivity against the laser beam.

Also, the laser welding apparatus according to the embodiment bonds, through the fusing operation, the end portions of the plurality of transferring optical fibers to the quartz block that is non-reflective coated, in order to overcome weakness of the coating on the end portions of the optical fibers and reduce the damage on the coating; and the connector may be configured to have a sealed structure by using the quartz block having a greater hardness than that of the optical fiber so that water cooling may be performed. Thus, damage to the transferring optical fiber may be prevented.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A laser welding apparatus comprising:
a plurality of laser diodes;
a plurality of transferring optical fibers connected to the plurality of laser diodes for transferring laser beams generated by the plurality of laser diodes;
a laser head irradiating the laser beams to a processing target; and
an optical connector for connecting the plurality of transferring optical fibers to the laser head, and for transferring the laser beams transferred through the plurality of transferring optical fibers to the laser head,
wherein the optical connector comprises an optical fiber block having an accommodation space for accommodating the plurality of transferring optical fibers so that an end portion of each of the plurality of transferring optical fibers is arranged in a first direction, and the laser head comprises an optical system for irradiating the laser beams emitted from the optical connector to the processing target.

2. The laser welding apparatus of claim 1, wherein the accommodation space has a width in the first direction and a height in a second direction that is perpendicular to the first direction, wherein the width is greater than the height.

3. The laser welding apparatus of claim 1, wherein surfaces of the end portions of the plurality of transferring optical fibers are non-reflective coated.

4. The laser welding apparatus of claim 3, wherein reflectivity on the surfaces of the end portions of the plurality of transferring optical fibers is less than 1%.

5. The laser welding apparatus of claim 1, wherein the laser beams irradiated to the processing target are respectively focused at a focal distance of a focusing lens.

6. The laser welding apparatus of claim 1, wherein the laser beams irradiated to the processing target form a line beam shape at a point out of a focal distance of a focusing lens.

7. The laser welding apparatus of claim 1, wherein a wavelength of the laser beam irradiated to the processing target is equal to a wavelength of the laser beam generated by the laser diode.

8. The laser welding apparatus of claim 1, wherein wavelengths of the laser beams generated respectively from the plurality of laser diodes are equal to or different from one another.

9. The laser welding apparatus of claim 1, wherein output power of the laser diodes ranges from 1 W to 10 kW.

10. The laser welding apparatus of claim 1, wherein the laser beams generated from the plurality of laser diodes have intensities that are equal to or different from one another.

11. The laser welding apparatus of claim 8, wherein the laser beam irradiated to the processing target has a wavelength ranging from 800 nm to 1000 nm.

12. The laser welding apparatus of claim 1, wherein the plurality of transferring optical fibers accommodated in the accommodation space are arranged in at least one row and a plurality of columns.

13. The laser welding apparatus of claim 1, wherein the optical fiber block has a surface facing the laser head, the surface comprising a material having reflectivity of 80% or greater against the laser beam.

14. The laser welding apparatus of claim 1, wherein the optical fiber block has thermal conductivity of 200 W/mK to 430 W/mK.

15. The laser welding apparatus of claim 13, wherein the optical fiber block comprises at least one of aluminum (Al), copper (Cu), silver (Ag), and gold (Au).

16. The laser welding apparatus of claim 1, wherein the optical connector further comprises a quartz block fused to bond to each of the end portions of the plurality of transferring optical fibers.

17. The laser welding apparatus of claim 16, wherein the quartz block has a surface facing the laser head, wherein the surface is non-reflective coated.

18. A laser welding apparatus comprising:
a plurality of laser diodes;
a plurality of transferring optical fibers connected to the plurality of laser diodes for transferring laser beams generated from the plurality of laser diodes;
a laser head irradiating the laser beams to a processing target; and
an optical connector connected to the plurality of transferring optical fibers, and transferring the laser beams transferred through the plurality of transferring optical fibers to the laser head,
wherein the optical connector comprises an optical fiber block having an accommodation space for accommodating the plurality of transferring optical fibers,
the laser head comprises an optical system disposed in front of the optical fiber block and irradiating the laser beams transferred through the plurality of transferring optical fibers to the processing target, and
the optical fiber block has a surface facing the laser head, and the surface has reflectivity of 80% or greater against the laser beam.

19. The laser welding apparatus of claim 18, wherein the optical fiber block has thermal conductivity of 200 W/mK to 430 W/mK.

20. The laser welding apparatus of claim 18, wherein the optical fiber block comprises at least one of aluminum (Al), copper (Cu), silver (Ag), and gold (Au).
